(19) United States
(12) Patent Application Publication
(10) Pub. No.: US 2025/0179964 A1
(43) Pub. Date: Jun. 5, 2025

(54) VARIABLE BLEED VALVE ASSEMBLIES

(71) Applicant: General Electric Company, Schenectady, NY (US)

(72) Inventors: Nageswar Rao Ganji, Bengaluru (IN); Hiranya Kumar Nath, Bengaluru (IN); Vishnu Vardhan Venkata Tatiparthi, Bengaluru (IN); Ravindra Shankar Ganiger, Bengaluru (IN); Jeffrey D. Carnes, Lynn, MA (US); Trevor H. Wood, Niskayuna, NY (US)

(21) Appl. No.: 18/440,383

(22) Filed: Feb. 13, 2024

(30) Foreign Application Priority Data
Aug. 14, 2023 (IN) 202311054511

(51) Int. Cl. F02C 9/18

(52) U.S. Cl. CPC F02C 9/18

(57) ABSTRACT

Example variable bleed valve assemblies for a gas turbine engine are disclosed herein. An example apparatus disclosed herein includes a variable bleed valve port extending radially outward from a main flow path of a gas turbine engine, a door positioned at an exit of the variable bleed valve port, the door including perforations, a damper coupled to the door, the damper including a resonator adjacent to the perforations of the door, the resonator defining an internal volume based on a resonant frequency of the variable bleed valve port.

### RELATED APPLICATION

This patent claims priority to Indian Provisional Patent Application No. 202311054511, filed on Aug. 14, 2023, which is incorporated herein by reference in its entirety.

### FIELD OF THE DISCLOSURE

This disclosure relates generally to turbine engines and, more particularly, to variable bleed valve assemblies.

### BACKGROUND

Turbine engines are some of the most widely used power generating technologies, often being utilized in aircraft and power-generation applications. A turbine engine generally includes a fan and a core arranged in flow communication with one another. The core of the turbine engine generally includes, in serial flow order, a compressor section, a combustion section, a turbine section on the same shaft as the compressor section, and an exhaust section. Typically, a casing or housing surrounds the core of the turbine engine.

### BRIEF DESCRIPTION OF THE DRAWINGS

FIG. 1 is a cross-sectional view of an example gas turbine engine in which examples disclosed herein may be implemented.

FIG. 2 is a partial cross-sectional side view of a compressor of the gas turbine engine example of FIG. 1 including a variable bleed valve assembly.

FIG. 3A is a side view of the compressor including the variable bleed valve assembly of FIG. 2.

FIG. 3B is a cross-sectional front view of the compressor including the variable bleed valve assembly of FIG. 2.

FIG. 4A is a partial cross-sectional side view of an example first variable bleed valve assembly including an example twin damper system in a closed position and in accordance with teachings disclosed herein.

FIG. 4B is a partial cross-sectional side view of the example first variable bleed valve assembly including the example twin damper system of FIG. 4A in an intermediate position and in accordance with teachings disclosed herein.

FIG. 4C is a partial cross-sectional side view of the example first variable bleed valve assembly including the example twin damper system of FIG. 4A in an open position and in accordance with teachings disclosed herein.

FIG. 5 is a block diagram of an example controller to adjust an attenuation range of the example twin damper system of FIGS. 4A-4C.

FIG. 6A is a partial cross-sectional side view of an example second variable bleed valve assembly including an example first damper assembly in accordance with teachings disclosed herein.

FIG. 6B is a partial cross-sectional side view of an example third variable bleed valve assembly including an example second damper assembly in accordance with teachings disclosed herein.

FIG. 7A is a partial cross-sectional side view of an example fourth variable bleed valve assembly including an example triangular damper assembly in accordance with teachings disclosed herein.

FIG. 7B is a partial cross-sectional side view of an example fifth variable bleed valve assembly including an example polygonal damper assembly in accordance with teachings disclosed herein.

FIG. 8 is a cross-sectional front view of an example sixth variable bleed valve assembly including an example damper system in accordance with teachings disclosed herein.

FIG. 9 is a flowchart representative of example machine readable instructions and/or example operations that may be executed by example programmable circuitry to implement the example controller of FIG. 5.

FIG. 10 is a block diagram of an example processing platform including programmable circuitry structured to execute the example machine readable instructions and/or the example operations of FIG. 9 to implement the example controller of FIG. 5.

The figures are not drawn to scale. Instead, the thickness of the layers or regions may be enlarged in the drawings. Although the figures show layers and regions with clean lines and boundaries, some, or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially same relationship is within three degrees of being the same, a substantially flush relationship is within three degrees of being flush, etc.).

As used herein, the terms “upstream” and “downstream” refer to locations along a fluid flow path relative to a direction of fluid flow from a first location to a second location. For example, with respect to a fluid flow, “upstream” refers to the first location from which the fluid flows, and “downstream” refers to the second location toward which the fluid flows. For example, with regard to a gas turbine engine, a compressor is said to be upstream of a turbine relative to a flow direction of air flowing through the engine.

Various terms are used herein to describe the orientation of features. In general, the attached figures are annotated with reference to the axial direction, radial direction, and circumferential direction of the vehicle associated with the features, forces, and moments. In general, the attached figures are annotated with a set of axes including the axial axis A, the radial axis R, and the circumferential axis C.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore provided to describe an exemplary implementation and not to be taken limiting on the scope of the subject matter described in this disclosure. Certain features from different aspects of the following description may be combined to form yet new aspects of the subject matter discussed below.

### DETAILED DESCRIPTION

A turbine engine, also referred to herein as a gas turbine engine, is a type of internal combustion engine that uses atmospheric air as a moving fluid. In operation, atmospheric air enters the turbine engine via a fan and flows through a compressor section where one or more compressors progressively compresses (e.g., pressurizes) the air until it reaches the combustion section. In the combustion section, the pressurized air is combined with fuel and ignited to produce a high-temperature, high-pressure gas stream (e.g., hot combustion gas) before entering the turbine section. The hot combustion gases expand as they flow a through a turbine section, causing rotating blades of one or more turbines to spin. The rotating blades of the turbine produce a spool work output that powers a corresponding compressor. The spool is a combination of the compressor, a shaft, and the turbine. Turbine engines often include multiple spools, such as a high pressure spool (e.g., HP compressor, shaft, and turbine) and a low pressure spool (e.g., LP compressor, shaft, and turbine). However, a turbine engine can include one spool or more than two spools in additional or alternative examples.

During low speed operation of the turbine engine (e.g., during start-up and/or stopping), equilibrium of the engine is adjusted. In many scenarios, a delay is needed for the spool(s) to adapt (e.g., a time for a rotational speed to adjust for a new equilibrium). However, the compressor cannot stop producing pressurized air for fuel combustion during operation. Such a result may cause the turbine to stop producing the power to turn the compressor, causing the compressor itself to stop compressing air. Accordingly, throttling changes may lead to compressor instabilities, such as compressor stall and/or compressor surge. Compressor stall is a circumstance of abnormal airflow resulting from the aerodynamic stall of rotor blades within the compressor. Compressor stall causes the air flowing through the compressor to slow down or stagnate. In some cases, the disruption of air flow as the air passes through various stages of the compressor can lead to compressor surge. Compressor surge refers to a stall that results in disruption (e.g., complete disruption, majority disruption, other partial disruption, etc.) of the airflow through the compressor.

A variable bleed valve (VBV) is often integrated into a compressor (e.g., at a downstream end of the LP compressor) to increase efficiency and limit possible stalls. The VBV enables the turbine engine to bleed air from a compressor section of the turbine engine during operation. An example VBV assembly or system includes a VBV port (e.g., opening, air bleed slot, etc.) including a VBV cavity extending from a compressor casing and a VBV door that opens via actuation. In other words, the VBV is configured as a cavity with a door that opens to provide a bleed flow path to bleed off compressed air between a booster (e.g., a low pressure compressor) and a core engine compressor of a gas turbine. For example, the VBV door may be actuated during a speed-to-speed mismatch between the LP spool and the HP spool. During start-up or stopping, the HP spool may spin at a lower speed than the LP spool. Opening the VBV port allows the LP spool to maintain its speed while reducing the amount of air that is flowing through the axial compressor by directing some of the air flow to the turbine exhaust area. Thus, the VBV door enables the LP spool (e.g., booster) to operate on a lower operating line and further away from a potential instability or stall condition.

In some VBV ports, the VBV door is not flush with the compressor casing, resulting in a bleed cavity that is open to a main flow path within the compressor. When the VBV door is closed, air of the main flow path flows over an opening of the VBV cavity. This causes the VBV port to acoustically resonate at a fixed frequency or a set of frequencies, similar to blowing air over an empty bottle. Such a phenomenon is referred to as Helmholtz resonance. More specifically, a shear layer of the main flow path is formed across an opening of the VBV cavity. The shear layer has oscillations that couple with the non-flowing air within the VBV cavity. The oscillations can be amplified based on the geometry of the VBV cavity and/or acoustically excite the air in the engine core. At certain resonant frequencies, acoustic excitations cause mechanical vibrations of the rotor system (e.g., rotor blades, rotor disks, rotor blisks (integrated rotor disk and blades), etc.) in the LP compressor. In some cases, the mechanical vibrations propagate and/or intensify upstream along the rotor system toward the initial rotor disk. Such mechanical excitation of the LP compressor can damage the rotor system and/or reduce booster performance. For example, one or more rotor blades of the initial rotor stage can crack due to excessive mechanical vibrations from the acoustic resonance of a closed-off VBV port (e.g., VBV cavity).

Some current means of reducing resonant frequencies include updates to Electric Engine Controls (EEC) and/or geometric modifications to the bleed-valve duct of the VBV assembly. For example, an EEC update can include processes for opening a VBV door in response to detecting a resonant frequency from the VBV assembly. Additionally, a geometric modification to the bleed-valve duct can include eccentric contour(s) and/or reduction in cavity volume to increase a frequency margin and/or reduce the problematic resonant response. However, such solutions are associated with relatively high costs, manufacturing resources, and/or decommission time. Accordingly, new VBV assemblies are needed to reduce the resonant frequencies of the VBV cavity when the VBV door is closed.

Some example VBV assemblies disclosed herein include a twin damper system coupled to a VBV door to reduce the VBV cavity acoustic resonance response. The twin damper system includes a first resonator and a second resonator to positioned on either side of a partition. As used herein, a “resonator” is an apparatus or system that resonates or generates sound waves at a certain frequency to cancel and/or absorb incident acoustic waves having the same or similar frequency. The first and second resonators are interconnected and can be selectively exposed to the VBV cavity to adjust the resonant frequency of the twin damper system.

Example VBV assemblies disclosed herein dampen the acoustic response of the air within the VBV cavity to reduce the oscillations of the air within the booster. Thus, disclosed examples enable the manufacture of VBV assemblies that reduce vibration of the LP compressor or booster at various resonant frequencies of the VBV cavity. In other words, example VBV assemblies disclosed herein reduce vibrational damage imparted to a rotor system of a booster while improving aerodynamic performance and/or efficiency of a turbine engine. Rotor blisk durability is thus improved using example VBV assemblies and example damper systems disclosed herein. Additionally, the take-off weight of the aircraft can be reduced by using rotor blisks of lower strength and/or material density due to the increased rotor durability. Example damper systems disclosed herein can be coupled to VBV doors of VBV assemblies (e.g., existing VBV assemblies) with relative ease without replacing and/or refabricating the entire VBV assembly.

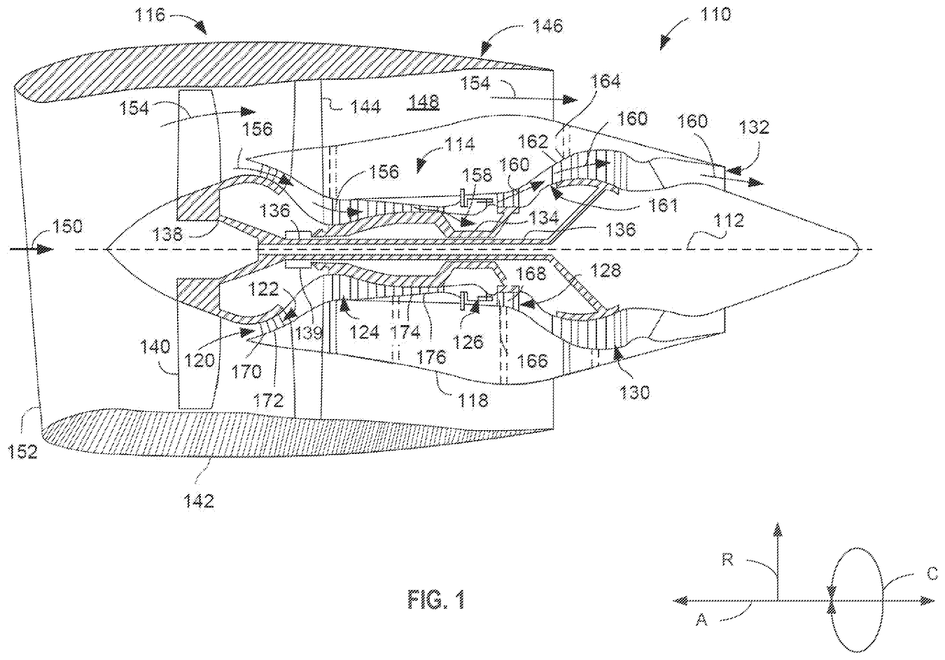

Referring now to the drawings, wherein identical numerals indicate the same elements throughout the figures, FIG. 1 is a schematic cross-sectional view of an example high-bypass turbofan-type gas turbine engine 110 (“turbofan engine 110”). While the illustrated example is a high-bypass turbofan engine, the principles of the present disclosure are also applicable to other types of engines, such as low-bypass turbofans, turbojets, turboprops, etc. As shown in FIG. 1, the turbofan engine 110 defines a longitudinal or axial centerline axis 112 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 112, the radial direction R is a direction that extends orthogonally outwardly from the centerline axis 112, and the circumferential direction C is a direction that extends concentrically around the centerline axis 112.

In general, the turbofan engine 110 includes a core turbine or gas turbine engine 114 disposed downstream from a fan section 116. The core turbine 114 includes a substantially tubular outer casing 118 that defines an annular inlet 120. The outer casing 118 can be formed from a single casing or multiple casings. The outer casing 118 encloses, in serial flow relationship, a compressor section having a booster or low pressure compressor 122 (“LP compressor 122”) and a high pressure compressor 124 (“HP compressor 124”), a combustion section 126, a turbine section having a high pressure turbine 128 (“HP turbine 128”) and a low pressure turbine 130 (“LP turbine 130”), and an exhaust section 132. A high pressure spool or shaft 134 (“HP shaft 134”) drivingly couples the HP turbine 128 and the HP compressor 124. A low pressure spool or shaft 136 (“LP shaft 136”) drivingly couples the LP turbine 130 and the LP compressor 122. The LP shaft 136 can also couple to a fan spool or shaft 138 of the fan section 116. In some examples, the LP shaft 136 is coupled directly to the fan shaft 138 (e.g., a direct-drive configuration). In alternative configurations, the LP shaft 136 can couple to the fan shaft 138 via a reduction gear 139 (e.g., an indirect-drive or geared-drive configuration).

As shown in FIG. 1, the fan section 116 includes a plurality of fan blades 140 coupled to and extending radially outwardly from the fan shaft 138. An annular fan casing or nacelle 142 circumferentially encloses the fan section 116 and/or at least a portion of the core turbine 114. The nacelle 142 can be supported relative to the core turbine 114 by a plurality of circumferentially spaced apart outlet guide vanes 144. Furthermore, a downstream section 146 of the nacelle 142 can enclose an outer portion of the core turbine 114 to define a bypass airflow passage 148 therebetween.

As illustrated in FIG. 1, air 150 enters an inlet portion 152 of the turbofan engine 110 during operation thereof. A first portion 154 of the air 150 flows into the bypass airflow passage 148, while a second portion 156 of the air 150 flows into the inlet 120 of the LP compressor 122. One or more sequential stages of LP compressor stator vanes 170 and LP compressor rotor blades 172 coupled to the LP shaft 136 progressively compress the second portion 156 of the air 150 flowing through the LP compressor 122 en route to the HP compressor 124. Next, one or more sequential stages of HP compressor stator vanes 174 and HP compressor rotor blades 176 coupled to the HP shaft 134 further compress the second portion 156 of the air 150 flowing through the HP compressor 124. This provides compressed air 158 to the combustion section 126 where it mixes with fuel and burns to provide combustion gases 160.

The combustion gases 160 flow through the HP turbine 128 where one or more sequential stages of HP turbine stator vanes 166 and HP turbine rotor blades 168 coupled to the HP shaft 134 extract a first portion of kinetic and/or thermal energy therefrom. This energy extraction supports operation of the HP compressor 124. The combustion gases 160 then flow through the LP turbine 130 where one or more sequential stages of LP turbine stator vanes 162 and LP turbine rotor blades 164 coupled to the LP shaft 136 extract a second portion of thermal and/or kinetic energy therefrom. This energy extraction causes the LP shaft 136 to rotate, thereby supporting operation of the LP compressor 122 and/or rotation of the fan shaft 138. The combustion gases 160 then exit the core turbine 114 through the exhaust section 132 thereof. A turbine frame 161 with a fairing assembly is located between the HP turbine 128 and the LP turbine 130. The turbine frame 161 acts as a supporting structure, connecting a high-pressure shaft's rear bearing with the turbine housing and forming an aerodynamic transition duct between the HP turbine 128 and the LP turbine 130. Fairings form a flow path between the high-pressure and low-pressure turbines and can be formed using metallic castings (e.g., nickel-based cast metallic alloys, etc.).

Along with the turbofan engine 110, the core turbine 114 serves a similar purpose and is exposed to a similar environment in land-based gas turbines, turbojet engines in which the ratio of the first portion 154 of the air 150 to the second portion 156 of the air 150 is less than that of a turbofan, and unducted fan engines in which the fan section 116 is devoid of the nacelle 142. In each of the turbofan, turbojet, and unducted engines, a speed reduction device (e.g., the reduction gear 139) can be included between any shafts and spools. For example, the reduction gear 139 is disposed between the LP shaft 136 and the fan shaft 138 of the fan section 116.

As described above with respect to FIG. 1, the turbine frame 161 is located between the HP turbine 128 and the LP turbine 130 to connect the high-pressure shaft's rear bearing with the turbine housing and form an aerodynamic transition duct between the HP turbine 128 and the LP turbine 130. As such, air flows through the turbine frame 161 between the HP turbine 128 and the LP turbine 130.

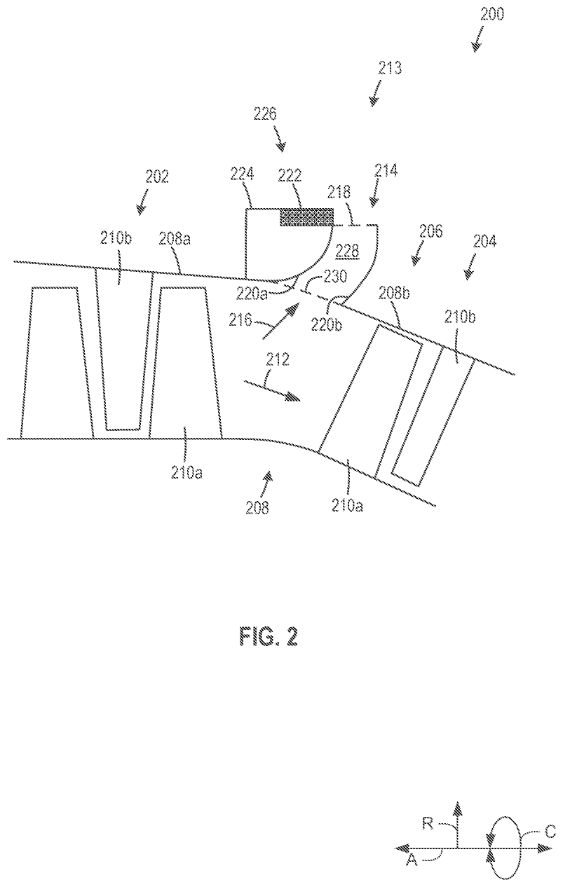

FIG. 2 is an illustration of a partial cross-sectional view of an example compressor 200 of a turbine engine (e.g., turbofan engine 110 of FIG. 1), including an example LP compressor or booster section 202 and an example HP compressor section 204. FIG. 2 illustrates the example compressor 200 at a transition point 206 between the booster section 202 and the HP compressor section 204. The compressor 200 includes an example casing 208. In the illustrated example of FIG. 2, the casing 208 surrounds the booster section 202 and the HP compressor section 204. In some examples, the booster section 202 and the HP compressor section 204 have distinct casings 208 connected via a linkage mechanism. The casing 208 surrounds rotor blades 210a and stator vanes 210b of the compressor 200. In operation, the rotor blades 210a spin, which impels air downstream. The stator vanes 210b redirect and reduce the airflow velocity, which increases the pressure downstream. The casing 208 defines an example main flow path 212 (e.g., a first flow path) for airflow through compressor 200 (e.g., and the turbofan engine 110).

As illustrated in example FIG. 2, a VBV system or VBV assembly 213 of the turbine engine includes a VBV port 214 (e.g., passage, opening, duct, etc.) to divert air from the main flow path 212 and circumvent the HP compressor section 204. The VBV port 214 defines an example bleed flow path 216 (e.g., secondary flow path) between the booster section 202 and a VBV port exit 218. More specifically, the VBV port 214 includes a fore VBV wall 220a and an aft VBV wall 220b extending radially outward between the LP compressor section 202 and the VBV port exit 218. In some examples, the fore and aft VBV walls 220a, 220b define an annular geometry of the VBV port 214.

In the illustrated example of FIG. 2, the VBV port 214 includes a VBV door 222 to restrict or permit airflow through the bleed flow path 216. The VBV assembly 213 includes a VBV actuation system 224 to actuate the VBV door 222 between an open position 226 and a closed position. For example, the VBV actuation system 224 can include one or more levers (e.g., a bell crank, etc.), linkages, and/or other actuation device(s) to slide the VBV door 222 between the open position 226 and the closed position. Thus, the VBV door 222 is actuatable (e.g., movable, translatable, rotatable, etc.) between the open position 226 and the closed position.

In the illustrated example of FIG. 2, the VBV door 222 and a VBV actuation system 224 are located adjacent to the VBV port exit 218. The VBV actuation system 224 causes the VBV door 222 (e.g., blocker door, etc.) to move to the closed position to cover the VBV port exit 218. When the VBV door 222 is in the closed position, the bleed flow path 216 is blocked and air is relatively stagnant in the VBV port 214 compared to the main flow path 212. In some examples, the VBV door 222, the fore VBV wall 220a, and the aft VBV wall 220b of the VBV port 214 define an example VBV cavity 228 when in the VBV door 222 is in the closed position. Thus, a shear layer of airflow extending across an entrance 230 to the VBV port 214 substantially confines a pocket of air within the VBV cavity 228. Air flow along the main flow path 212 and the shear layer oscillates and causes the air within the VBV cavity 228 to resonate at various frequencies. Such acoustic resonance of the VBV bleed cavity 228 can lead to acoustic excitations in the booster section 202 and compressor instabilities. Advantageously, example VBV assemblies disclosed herein include acoustic liners to attenuate the acoustic resonance of the VBV cavity 228.

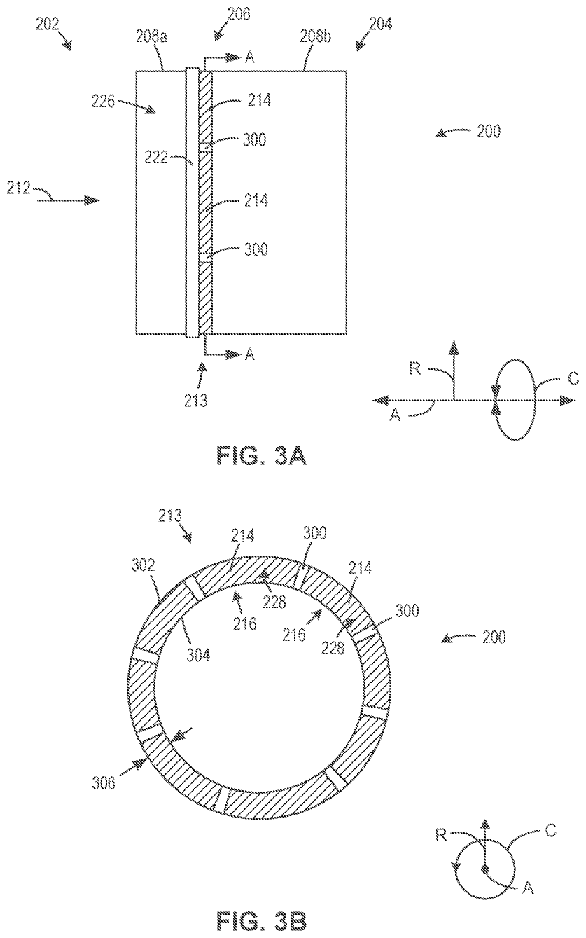

FIG. 3A is a side view of the example compressor 200 of FIG. 2 including a first variable bleed valve assembly 213 that can be implemented in a turbine engine (e.g., turbofan engine 110 of FIGS. 1 and/or 2). FIG. 3B is a cross-sectional front view of the example compressor 200 of FIG. 3A taken along line A-A. In the illustrated examples of FIGS. 3A and 3B, the VBV door 222 is in the open position 226. Thus, the VBV door 222 is not visible in FIG. 3B.

In the illustrated examples of FIGS. 3A and 3B, a booster casing 208a surrounds the booster section 202 of the compressor 200, and a compressor casing 208b surrounds the HP compressor section 204 of the compressor 200. The booster casing 208a is coupled to the compressor casing 208b at the transition point 206. The VBV assembly 213 includes one or more VBV ports 214 integrated into the casing 208 to bleed air from the main flow path 212. In some examples, the VBV ports 214 are formed at the transition point 206 between the booster and compressor casings 208a, 208b. For example, the booster casing 208a can include the fore VBV wall 220a (FIG. 2) and the compressor casing 208b can include the aft VBV wall 220b (FIG. 2). Thus, the VBV ports 214 can be created based on a coupling of the casings 208a, 208b. In some examples, the VBV ports 214 are machined into the casing 208. In some examples, an additive manufacturing process integrates the VBV ports 214 into the casing 208. Additionally or alternatively, the VBV ports 214 can be manufactured separately and coupled (e.g., welded, bolted, etc.) to the casing 208.

In some examples, the VBV assembly 213 selectively bleeds air based on a number of the VBV ports 214. For example, the casing 208 can include between 8 and 18 VBV ports 214 based on a target bleed flowrate. In some examples, respective ones of the VBV ports 214 include a door that can actuate between an open and closed position to adjust the bleed flowrate of the VBV assembly 213 based on a target bleed flowrate and/or a flight condition of the aircraft. In some examples, the VBV assembly 213 includes a single unified VBV port 214 that continually extends circumferentially about a longitudinal axis of the compressor 200 (e.g., the axial centerline axis 112 of FIG. 1). In the illustrated examples of FIGS. 3A and 3B, the VBV assembly 213 includes a plurality of partitions 300 to define the VBV ports 214. That is, the partitions 300 circumferentially separate adjacent ones of the VBV ports 214. The plurality of partitions 300 are spaced circumferentially about compressor 200 at a substantially similar axial and radial positions.

In the illustrated example of FIG. 3B, the booster casing 208a and the compressor casing 208b include an example outer surface 302 and an example inner surface 304. In the example of FIG. 3B, a dimension 306 of FIG. 3B corresponds to a thickness of the casings 208a, 208b and/or a radial length of the VBV ports 214. For example, the compressor casing 208b expands radially outward by the dimension 306 from the inner surface 304 to the outer surface 302. In some examples, the VBV ports 214 extend radially beyond the outer surface 302 and has a radial length that is greater than the dimension 306.

In the illustrated example of FIG. 3B, each of the VBV ports 214 include the VBV cavity 228 of FIG. 2. In some examples, the VBV ports 214 are similarly sized and the VBV cavities 228 have similar volumes. Alternatively, ones of the VBV ports 214 can have variable sizes and ones of the VBV cavities 228 have different volumes based on respective positions of the partitions 300. However, in some examples, the VBV assembly 213 includes the single (e.g., unified, continuous, etc.) VBV port 214 such that the VBV cavity 228 extends circumferentially about the longitudinal axis of the compressor 200.

Various example VBV assemblies in accordance with the teachings of this disclosure are described in further detail below. Examples disclosed below are applied to the example compressor 200 of the example turbofan engine 110 as described in FIGS. 2, 3A, and 3B. Accordingly, examples disclosed below include the example casing 208 (e.g., the booster casing 208a and the compressor casing 208b), which defines the main flow path 212, and the example VBV port(s) 214, which defines the example bleed flow path 216. It is understood, however, that examples disclosed herein may be implemented in one or more compressors, such as a high pressure compressor, a low pressure compressor, etc. Further, examples disclosed herein may be implemented on a compressor having a variety of configurations, such as including one or more VBV ports, compressor stages, etc. Further, examples disclosed herein may be applied to a variety of turbine engines, such as a multi-spool turbine engine, a turboshaft engine, turbine engines with one compressor section, etc. Examples disclosed below may include the controller to determine to actuate the VBV assemblies disclosed herein.

The VBV ports 214 of the VBV assembly 213 of FIGS. 2, 3A, and 3B can resonate at an acoustic frequency based on the volume of the VBV cavity 228. That is, when the VBV door 222 is in the closed position and air flows across the entrance 230 (FIG. 2), the VBV port 214 of FIG. 2 resonates at the acoustic frequency, also referred to herein as the resonant frequency. Thus, the VBV assembly 213 can generate airwave oscillations in the booster section 202 of the compressor 200 that excite the mechanical components (e.g., rotor blades 210a, stator vanes 210b, etc.) of the booster section 202.

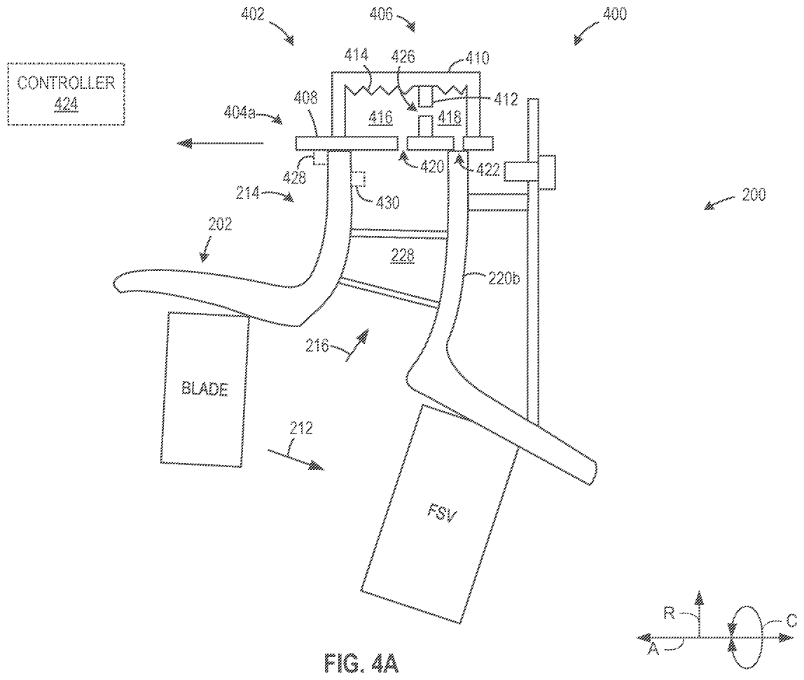

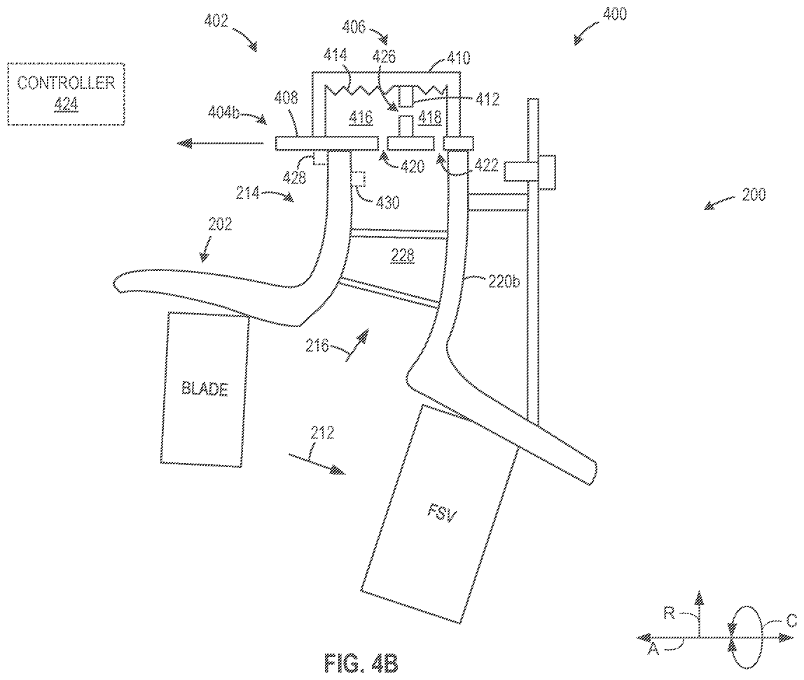

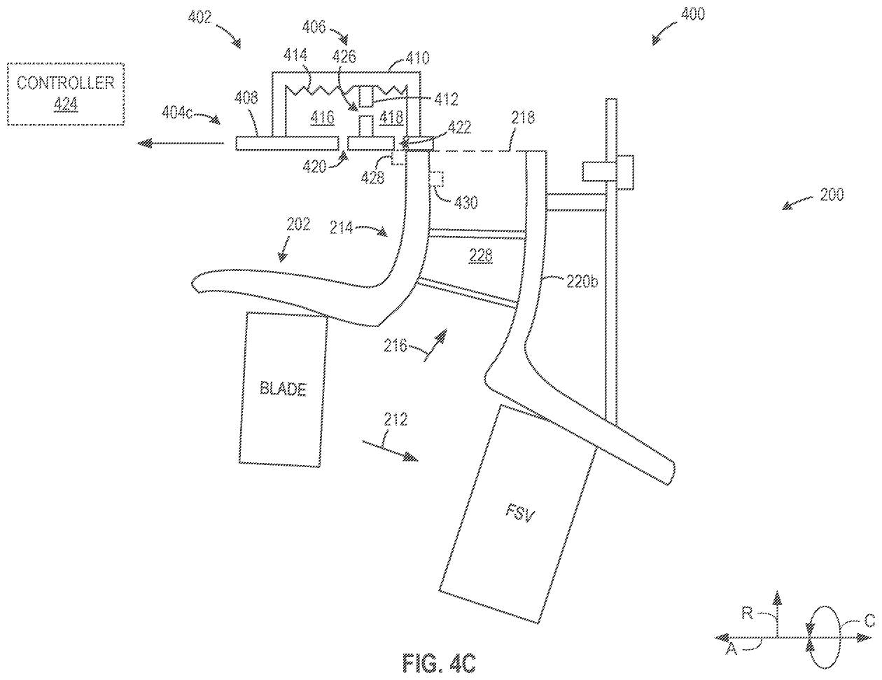

FIGS. 4A, 4B, and 4C are partial cross-sectional side views of the example compressor 200 of FIG. 2 including an example first VBV assembly 400 (e.g., a first VBV system) in accordance with teachings disclosed herein. The first VBV assembly 400 includes a twin damper system 402 to reduce acoustic energy that the VBV port 214 generates when air on the main flow path 212 causes the VBV port 214 to resonate. FIG. 4A shows the twin damper system 402 in a closed position 404a, FIG. 4B shows the twin damper system 402 in an intermediate position 404b, and FIG. 4C shows the twin damper system 402 in an open position 404c. Many of the components of the example first VBV assembly 400 of FIGS. 4A-4C are substantially similar or identical to the components described above in connection with the VBV assembly 213 of FIGS. 2, 3A, and 3B. Thus, for the figures disclosed herein, identical numerals indicate the same elements throughout the figures.

In the illustrated examples of FIGS. 4A-4C, the twin damper system 402 includes a body 406 coupled to a VBV door 408 of the first VBV assembly 400. The body 406 includes a shell 410 and an interior partition 412. The interior partition is coupled to the VBV door 408 and an interior surface 414 of the body 406. The interior surface 414 is substantially parallel to the VBV door 408 and radially spaced from the VBV door 408. Furthermore, the interior partition 412 extends circumferentially along the VBV door 408. Thus, the shell 410 and the interior partition 412 define a first damper or first resonator 416 and a second damper or second resonator 418 within the body 406. Furthermore, the twin damper system 402 includes a first door hole 420 (e.g., first perforations) positioned adjacent to the first resonator 416 and a second door hole 422 (e.g., second perforations) positioned adjacent to the second resonator 418. The first door hole 420 allows air pressure oscillations to propagate into the first resonator 416 when the first door hole 420 is exposed to the VBV cavity 228. Similarly, the second door hole 422 allows air pressure oscillations to propagate into the second resonator 418 when the second door hole 422 is exposed to the VBV cavity 228.

In the illustrated examples of FIGS. 4A-4C, the first resonator 416 defines a first internal volume, and the second resonator 418 defines a second internal volume different than (e.g., smaller than) the first internal volume. In some examples, an internal volume of a resonator (e.g., a volume of a resonant cavity) defines a resonant frequency that the resonator attenuates (e.g., absorbs). The larger an internal volume of a resonator, the lower the resonant frequency of the resonator and the lower the resonant frequency that the resonator is able to attenuate or cancel. Thus, the twin damper system 402 includes the first resonator 416 to absorb (e.g., attenuate, reduce, counteract, etc.) a first resonant frequency and the second resonator 418 to absorb a second resonant frequency, different than the first resonant frequency. In the illustrated examples of FIGS. 4A-4C, the second resonant frequency is higher than the first resonant frequency based on the first and second internal volumes of the first and second resonators 416, 418. More specifically, as acoustic waves (e.g., pressure oscillations) enter the first resonator 416 via the first door hole 420, the waves reflect off of interior surfaces of the first resonator 416, which causes the first resonator 416 to attenuate a first resonant frequency.

In some cases, as two adjacent structures resonate at a similar frequency, the amplitudes of the resonating acoustic waves are attenuated or canceled. Additionally, a resonant frequency emitted from a cavity (e.g., the VBV cavity 228) can change based on a speed or flowrate of flowing air over an open end of the cavity. For example, the VBV cavity 228 can have two “resonant modes.” That is, the VBV port 214 can emit two different resonant frequencies based on the speed of the air flow along the main flow path 212. The VBV port 214 can resonate at a first resonant frequency (e.g., 500 Hz, etc.) when air along the main flow path 212 flows at a first speed (e.g., 350 miles per hour, etc.) and a second resonant frequency (e.g., 850 Hz, etc.) when the air flows at a second speed (e.g., 500 miles per hour, etc.). The first resonant frequency being lower than the second resonant frequency, and the first speed being lower than the second speed. Thus, in the illustrated examples of FIGS. 4A-4C, the first resonator 416 can resonate at the first resonant frequency based on the first internal volume to match and attenuate the first resonant frequency of the VBV cavity 228 and/or the VBV port 214. Furthermore, the second resonator can resonate at the second resonant frequency based on the second internal volume to match and attenuate the second resonant frequency of the VBV cavity 228 and/or the VBV port 214.

Furthermore, the VBV door 408 is slidable between the closed position 404a and the open position 404c. Thus, the twin damper system 402 is actuatable between the closed position 404a of FIG. 4A, the intermediate position 404b of FIG. 4B, and the open position 404c of FIG. 4C using an actuation system (e.g., the VBV actuation system 224 of FIG. 2) or a controller 424. In the closed position 404a, the aft VBV wall 220b obstructs the second door hole 422. Thus, acoustic waves can enter the first resonator 416 via the first door hole 420 when the twin damper system 402 is in the closed position 404a. In other words, when the twin damper system 402 is in the closed position 404a of FIG. 4A, the first resonator 416 can dampen the first resonant frequency or the lower resonant mode (e.g., 600 Hz, etc.) of the VBV port 214. Additionally, the controller 424 can move the twin damper system 402 to the intermediate position 404b to allow pressure driven acoustic waves to enter the second resonator 418 via the second door hole 422. The intermediate position 404b allows the second door hole 422 to be opened/exposed while the VBV door 408 is still able to block/obstruct the VBV port exit 218 of FIG. 4C. Thus, when the twin damper system 402 is in the intermediate position 404b of FIG. 4B, the second resonator 418 can dampen the second resonant frequency (e.g., the higher frequency) of the VBV port 214. In some examples, the fore VBV wall 220a obstructs the first door hole 420 when the twin damper system is in the intermediate position 404b.

In the illustrated examples of FIGS. 4A-4C, the interior partition 412 includes a partition hole 426 to allow air pressure waves to flow in between the first and second resonators 416, 418. In some examples, when the twin damper system 402 is in the closed position 404a of FIG. 4A, the partition hole 426 allows reflected acoustic waves to enter the second resonator 418 from the first resonator 416. The reflected waves that enter the second resonator 418 via the partition hole 426 continue to reflect within the second resonator 418, which causes additional acoustic damping. Thus, the twin damper system 402 operates as a single damper-in-damper when in the closed position 404a. In other words, the first resonator 416 and the second resonator 418 can operate as two interconnected dampers in series such that the second resonator can still provide an attenuating benefit while the second door hole 422 is obstructed. Furthermore, when the twin damper system 402 is in the intermediate position 404b of FIG. 4B, the partition hole 426 enables reflected acoustic waves from the second resonator 418 to further reflect with the first resonator 416, which also causes additional acoustic damping. Thus, the twin damper system 402 operates as two interconnected dampers when in the intermediate position 404b.

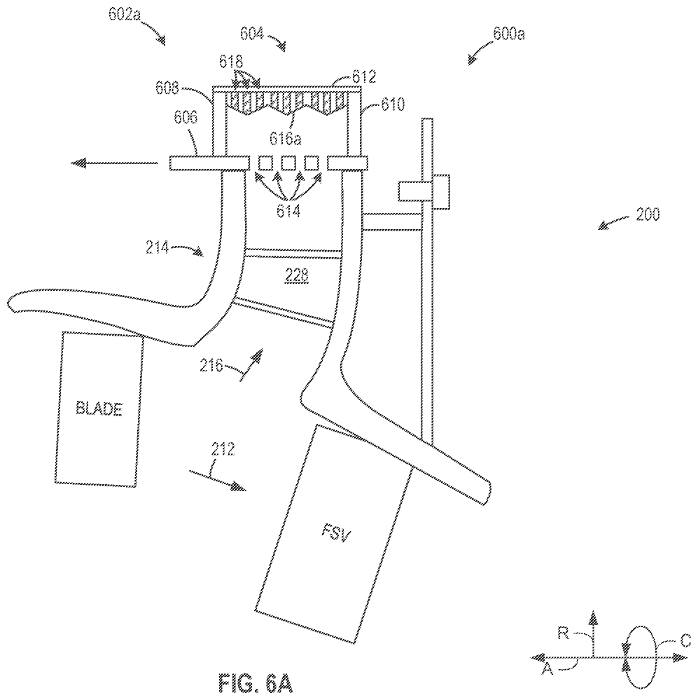

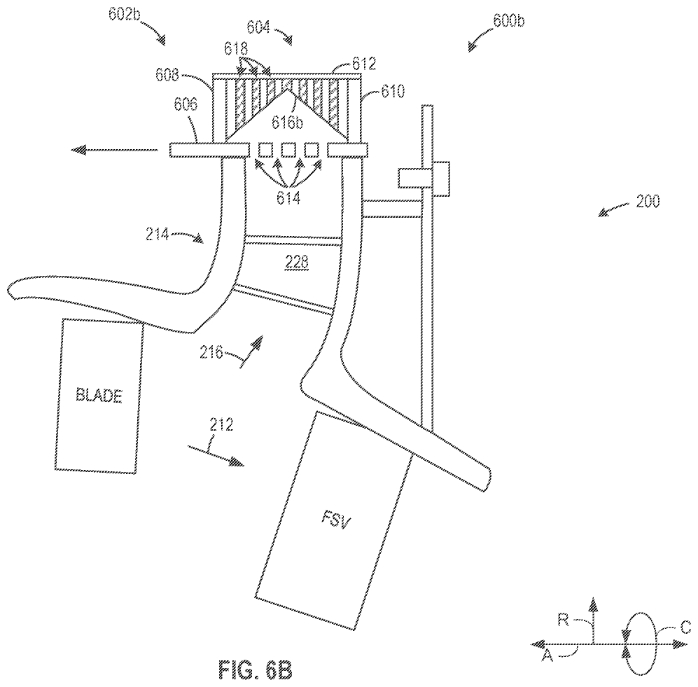

In the illustrated examples of FIGS. 4A-4C, the interior surface 414 of the body 406 is non-uniform (e.g., undulating, ridged, jagged, etc.) to increase the dampening properties of the first and second resonators 416, 418. More specifically, a ridged surface profile of the interior surface 414 causes acoustic waves to reflect in various and/or random directions within the first and second resonators 416, 418. Thus, more interaction occurs between the reflected waves and incident acoustic waves that enter through the first and/or second door holes 420, 422, which further dampens the resonating waves that enter the first and second resonators 416, 418. Additionally or alternatively, the interior surface 414 or portion(s) of the interior surface 414 can be flat and/or smoothly undulating (e.g., curved, wavy, domed, etc.). In some examples, the twin damper system 402 includes an acoustic liner (e.g., a quarter wave panel) coupled to the interior surface 414 to provide further acoustic damping. For example, the acoustic liner coupled to the interior surface 414 can correspond to the acoustic liners described below in connection with FIGS. 6A and/or 6B.

In the illustrated examples of FIGS. 4A-4C, the twin damper system 402 includes a position sensor 428 to detect a position of the VBV door 408, such as the closed position 404a, the intermediate position 404b, the open position 404c, or another intermediary position. For example, the position sensor 428 can be a capacitive displacement sensor, a hall effect sensor, a linear variable differential transformer (LVDT), or another type of sensor that can measure a positional displacement of the VBV port 214. The controller 424 can obtain positional data (e.g., displacement measurements) from the position sensor 428 based on a signal from an acoustic sensor 430 and/or on a continual or periodic basis (e.g., every second, minute, etc.).

In the illustrated examples of FIGS. 4A-4C, the twin damper system 402 includes the acoustic sensor 430 to detect an acoustic frequency of the VBV port 214, such as the first resonant frequency corresponding to the first resonant mode of the VBV port 214 and/or the second resonant frequency corresponding to the second resonant mode of the VBV port 214. The acoustic sensor 430 can be pressure transducers capable of detecting low frequency airborne pressure waves impinging on cavity walls (e.g., the fore VBV wall 220a, the aft VBV wall 220b, etc.) and/or another type of acoustic sensor that can detect and/or measure frequencies of acoustic resonance.

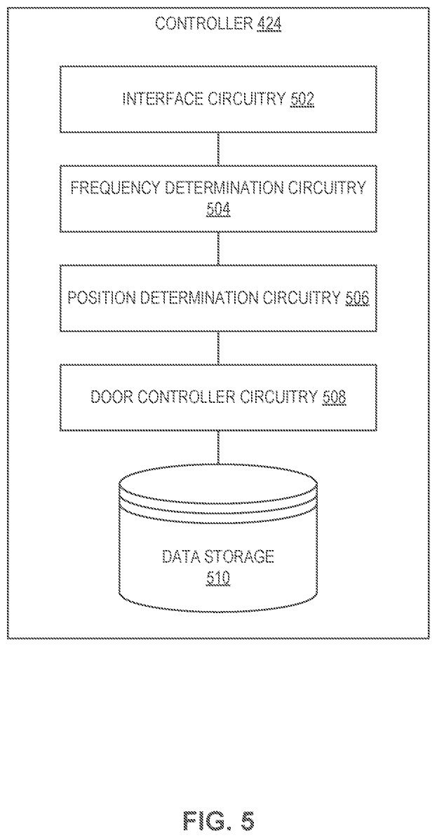

The controller 424 of the illustrated examples of FIGS. 4A-4C can obtain position data from the position sensor 428 and frequency data from the acoustic sensor 430 to determine how to actuate the twin damper system 402. For example, when the acoustic sensor 430 detects that the VBV port 214 is resonating at the second resonant frequency (e.g., the higher resonant mode), the controller 424 can actuate or move the VBV door 408 to the intermediate position 404b of FIG. 4B. In another example, when the acoustic sensor 430 detects that the VBV port 214 is resonating at the first resonant frequency (e.g., the lower resonant mode), the controller 424 can actuate or move the VBV door 408 to the closed position 404a. In some examples, the controller 424 moves the VBV door 408 to the intermediate position 404b when a resonant frequency of the VBV port 214 satisfies a threshold (e.g., 600 Hz, etc.). Similarly, the controller 424 can move the VBV door 408 to the closed position 404a when the resonant frequency of the VBV port 214 does not satisfy the threshold. Further descriptions of the controller 424 are provided in connection with FIG. 5.

Additionally or alternatively, the controller 424 can actuate the twin damper system 402 based on a flight condition of the aircraft and/or gas turbine engine. The resonant frequency of the VBV port 214 is based on the geometry of the VBV cavity and the air speed along the main flow path 212. Thus, the controller 424 can determine the resonant frequency that the VBV port 214 is likely generating based on a flight condition (e.g., cruise speed, takeoff speed, landing speed, etc.) of the aircraft. For example, the controller 424 can obtain an air speed of the aircraft from an avionics system and/or an air speed indicator and can move the twin damper system 402 to the intermediate position 404b when the air speed satisfies a speed threshold (e.g., 700 mph, etc.).

FIG. 5 is a block diagram of the controller 424 to adjust a resonant frequency range that the twin damper system 402 is able to attenuate. Thus, the controller 424 can ensure that the position of the VBV door 408 and of FIGS. 4A-4C enables the twin damper system 402 to attenuate or dampen the resonant frequencies of the VBV port 214 based on the resonant frequency of the VBV port 214 and/or the operating speed or flight condition of the aircraft. More specifically, the controller 424 can adjust the position of the twin damper system 402 to selectively occlude/obstruct and/or expose/open the first door hole 420 and/or the second door hole 422 to activate the first resonator 416 and/or the second resonator 418.

The controller 424 of the illustrated example of FIG. 5 includes example interface circuitry 502, example frequency determination circuitry 504, example position determination circuitry 506, example door controller circuitry 508, and example data storage 510. The controller 424 of FIGS. 4A, 4B, 4C, and 5 may be instantiated (e.g., creating an instance of, bring into being for any length of time, materialize, implement, etc.) by programmable circuitry such as a central processing unit executing instructions. Additionally or alternatively, the controller 424 of FIGS. 4A, 4B, 4C, and 5 may be instantiated (e.g., creating an instance of, bring into being for any length of time, materialize, implement, etc.) by application specific integrated circuit(s) (ASIC(s)) or Field Programmable Gate Array(s) (FPGA(s)) structured to perform operations corresponding to the instructions. It should be understood that some or all of the circuitry of FIG. 5 may, thus, be instantiated at the same or different times. Some or all of the circuitry may be instantiated, for example, in one or more threads executing concurrently on hardware and/or in series on hardware. Moreover, in some examples, some or all of the circuitry of FIG. 5 may be implemented by microprocessor circuitry executing instructions to implement one or more virtual machines and/or containers.

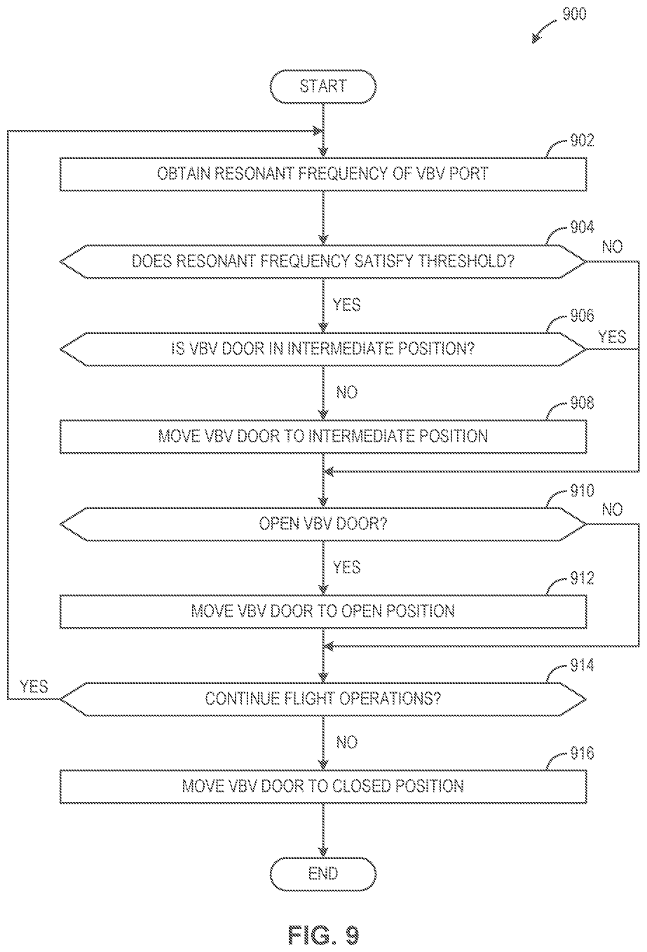

The controller 424 includes the interface circuitry 502 to synchronize operation between input/output device(s) and circuitry (e.g., processor circuitry) of the controller 424. In some examples, the interface circuitry 502 is instantiated by programmable circuitry executing interface instructions and/or configured to perform operations such as those represented by the flowchart of FIG. 9. In some examples, an aircraft that implements the twin damper system 402 of FIGS. 4A-4C includes the input device(s) (e.g., switch(es), dial(s), button(s), knob(s), keyboard(s), touchpad(s), etc.) in a cockpit or another control center onboard. Using such input device(s), the operator can cause the twin damper system 402 to actuate between the closed position 404a of FIG. 4A, the intermediate position 404b of FIG. 4B, and the open position 404c of FIG. 4C. For example, when the aircraft has landed and/or completed flight operations, the pilot can provide an input to the controller 424 to move the twin damper system 402 to the closed position 404a. Furthermore, the interface circuitry 502 allows the controller 424 to communicate with the position sensor 428 and the acoustic sensor 430. For example, the interface circuitry 502 can obtain positional data from the position sensor 428 and frequency data from the acoustic sensor 430. Additionally or alternatively, the interface circuitry 502 can enable the controller to obtain air speed data from a control system of the aircraft (e.g., an air speed indicator, an avionics system, etc.).

The controller 424 includes the frequency determination circuitry 504 to detect the resonant frequency of the VBV port 214 of FIGS. 4A-4C. Additionally or alternatively, the controller 424 includes the frequency determination circuitry 504 to determine whether the resonant frequency of the VBV port 214 satisfies a threshold value. More specifically, the frequency determination circuitry 504 obtains data (e.g., frequency data) from the acoustic sensor 430 and/or the interface circuitry 502 and detects the resonant frequency within the VBV cavity 228 of FIGS. 4A-4C. The frequency determination circuitry 504 can then determine whether the resonant frequency satisfies (e.g., is greater than or equal to) the threshold. In some examples, the frequency determination circuitry 504 is instantiated by programmable circuitry executing frequency determination instructions and/or configured to perform operations such as those represented by the flowchart of FIG. 9. The frequency determination circuitry 504 can function as a closed loop controller that obtains input feedback data (e.g., the resonant frequency) from the acoustic sensor 430 and sends output data (e.g., position of the VBV door 408) to the door controller circuitry 508 of the controller 424.

The controller 424 of the example of FIG. 5 includes the position determination circuitry 506 to determine a position of the VBV door 408 based on data from the position sensor 428 of FIGS. 4A-4C and/or input devices in a cockpit of an aircraft. More specifically, the position determination circuitry 506 obtains data (e.g., positional displacement measurements) from the position sensor 428 and detects the position of the twin damper system 402 based on the data. In some examples, the position determination circuitry 506 is instantiated by programmable circuitry executing position determination instructions and/or configured to perform operations such as those represented by the flowchart of FIG. 9. The position determination circuitry 506 can function as a closed loop controller that obtains input feedback data (e.g., acoustic measurements, frequency measurements, etc.) from the frequency determination circuitry 504 and sends output data (e.g., target position of the VBV door 408) to the door controller circuitry 508 of the controller 424.

The controller 424 of the example of FIG. 5 includes the door controller circuitry 508 to adjust the position of the VBV door 408 and the twin damper system 402 of FIGS. 4A-4C. More specifically, the door controller circuitry 508 receives signals indicating a target VBV door position and/or a target resonant frequency of the VBV port 214. The door controller circuitry 508 can then cause the VBV door 408 to move to a position (e.g., the closed position 404a, the intermediate position 404b, the open position 404c, etc.) to obstruct and/or exposed the first door hole 420 and/or the second door hole 422 based on the resonant frequency the twin damper system 402 is to attenuate.

In some examples, the door controller circuitry 508 is instantiated by programmable circuitry executing door controller instructions and/or configured to perform operations such as those represented by the flowchart of FIG. 9. In some examples, the door controller circuitry 508 is configured as a closed loop controller that receives positional feedback from the position sensor 428 and/or the interface circuitry 502 and continues to send output signals that cause actuation of the VBV door 408 until the door controller circuitry 508 determines that the twin damper system 402 is in a target position.

The controller 424 includes the data storage 510 to store data (e.g., position measurements, frequency measurements, air speed measurements, thresholds, etc.) or any information associated with the interface circuitry 502, the frequency determination circuitry 504, the position determination circuitry 506, and/or the door controller circuitry 508. The example data storage 510 of the illustrated example of FIG. 5 can be implemented by any memory, storage device and/or storage disc for storing data, such as flash memory, magnetic media, optical media, etc. Furthermore, the data stored in the example data storage 510 can be in any data format such as binary data, comma delimited data, tab delimited data, structured query language (SQL) structures, image data, etc.

While an example implementation of the controller 424 of FIGS. 4A-4C is illustrated in FIG. 5, one or more of the elements, processes, and/or devices illustrated in FIG. 5 may be combined, divided, re-arranged, omitted, eliminated, and/or implemented in another way. Further, the example interface circuitry 502, the example frequency determination circuitry 504, the example position determination circuitry 506, the example door controller circuitry 508, and/or, more generally, the example controller 424 of FIGS. 4A-4C, may be implemented by hardware alone or by hardware in combination with software and/or firmware. Thus, for example, any of the example interface circuitry 502, the example frequency determination circuitry 504, the example position determination circuitry 506, the example door controller circuitry 508, and/or, more generally, the example controller 424, could be implemented by programmable circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGA(s). Further still, the example controller 424 of FIGS. 4A-4C may include one or more elements, processes, and/or devices in addition to, or instead of, those illustrated in FIG. 5, and/or may include more than one of any or all of the illustrated elements, processes, and devices.

FIG. 6A is a partial cross-sectional side view of the example compressor 200 of FIG. 2 including an example second VBV assembly 600a (e.g., a second VBV system) in accordance with teachings disclosed herein. FIG. 6B is a partial cross-sectional side view of the example compressor 200 of FIG. 2 including an example third VBV assembly 600b (e.g., a third VBV system) in accordance with teachings disclosed herein. Many of the components of the example second VBV assembly 600a of FIG. 6A and the third VBV assembly 600b of FIG. 6B are substantially similar or identical to the components described above in connection with the VBV assembly 213 of FIGS. 2, 3A, and 3B. Thus, for the figures disclosed herein, identical numerals indicate the same elements throughout the figures.

The second VBV assembly 600a includes a first damper assembly 602a to reduce acoustic energy that the VBV port 214 generates when air on the main flow path 212 causes the VBV port 214 to resonate. Similarly, the third VBV assembly 600b includes a second damper assembly 602b to reduce acoustic energy resonating from the VBV port 214. The first damper assembly 602a is similar to the second damper assembly 602b. Thus, unless otherwise specified, descriptions provided in connection with the first damper assembly 602a can also apply to the second damper assembly 602b.

The first damper assembly 602a includes a resonator or a body 604 coupled to a door 606. The body 604 includes a fore wall 608, an aft wall 610, and an outer wall 612. The door 606 includes a plurality of door holes 614 adjacent to the body 604. The door holes 614 allow air pressure oscillations to enter into the body 604 and internally reflect off of interior surfaces of the body 604 to reduce the energy of the sound waves that entered. In some examples, the resonant frequency the first damper assembly 602a is able to attenuate is based on an internal volume of the first damper assembly 602a and a number and/or dimension of the door holes 614.

Furthermore, the first damper assembly 602a of FIG. 6A includes a first acoustic liner 616a, and the second damper assembly 602b of FIG. 6B includes a second acoustic liner 616b to further absorb the sound waves resonating from the VBV port 214. The first acoustic liner 616a is disposed within the body 604 of the first damper assembly 602a. The second acoustic liner 616b is disposed within the body 604 of the second damper assembly 602b. In the illustrated example of FIG. 6A, the first acoustic liner 616a includes a ridged surface profile. In the illustrated example of FIG. 6B, the second acoustic liner 616b includes a triangular surface profile. In some examples, the first and second acoustic liners 616a, 616b are quarter wave panels. As used herein, a quarter wave panel is an acoustic liner including cavities with a depth corresponding to one quarter the wavelength of the sound waves (e.g., resonant frequencies) to be dampened. In other words, the first and second acoustic liners 616a, 616b can include panels with cavities 618 extending through the panel to the outer wall 612. In some examples, the acoustic liners 616a, 616b are composite honeycomb panels coupled to the outer wall 612. Because of the non-uniform (e.g., ridged, triangular, etc.) profiles of the first and second acoustic liners 616a, 616b, the cavities 618 can be variable in depth. Thus, the irregular profiles of the acoustic liners 616a, 616b cause the first and second damper assemblies 602a, 602b to attenuate a range of resonant frequencies from the VBV port 214. Furthermore, the non-linearity of the acoustic liners 616a, 616b can cause the acoustic waves to reflect within the body 604 in complex patterns.

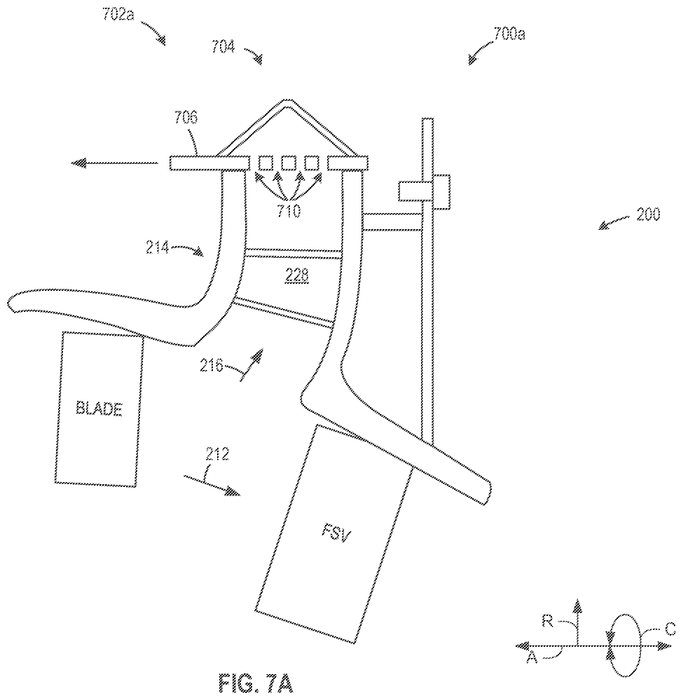

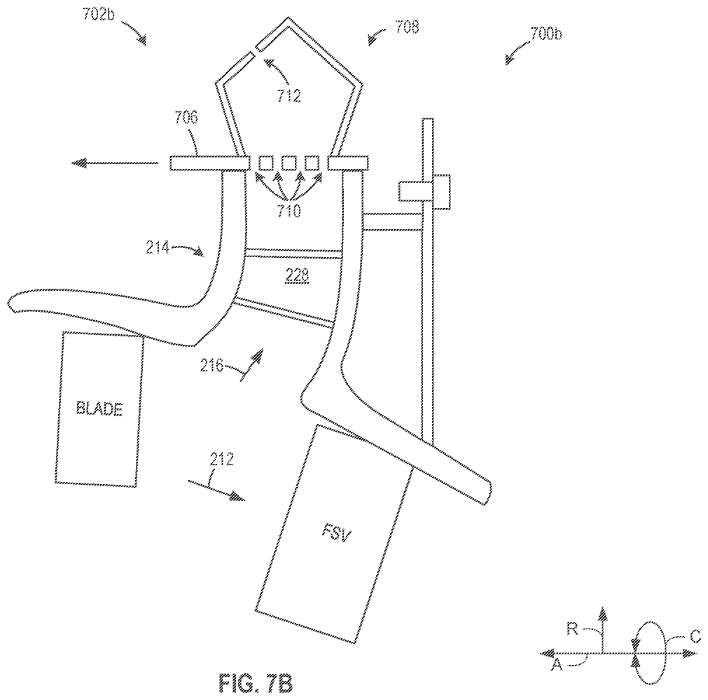

FIG. 7A is a partial cross-sectional side view of the example compressor 200 of FIG. 2 including an example fourth VBV assembly 700a (e.g., a fourth VBV system) in accordance with teachings disclosed herein. FIG. 7B is a partial cross-sectional side view of the example compressor 200 of FIG. 2 including an example fifth VBV assembly 700b (e.g., a fifth VBV system) in accordance with teachings disclosed herein. Many of the components of the example fourth VBV assembly 700a of FIG. 7A and the fifth VBV assembly 700b of FIG. 7B are substantially similar or identical to the components described above in connection with the VBV assembly 213 of FIGS. 2, 3A, and 3B. Thus, for the figures disclosed herein, identical numerals indicate the same elements throughout the figures.

The fourth VBV assembly 700a includes a triangular damper assembly 702a to reduce acoustic energy that the VBV port 214 generates when air on the main flow path 212 causes the VBV port 214 to resonate. Similarly, the fifth VBV assembly 700b includes a polygonal damper assembly 702b to reduce acoustic energy resonating from the VBV port 214.

The triangular damper assembly 702a of FIG. 7A includes a triangular resonator or a triangular body 704 coupled to a door 706. The polygonal damper assembly 702b of FIG. 7B includes a polygonal resonator or a polygonal body 708 coupled to the door 706. The door 706 includes a plurality of door holes 710 adjacent to the bodies 704, 708 of FIGS. 7A and 7B. The door holes 710 allow air pressure oscillations to enter into the bodies 704, 708 and internally reflect off of interior surfaces of the bodies 704, 708 to reduce the energy of the sound waves that entered. In some examples, the resonant frequencies that the triangular damper assembly 702a and the polygonal damper assembly 702b can attenuate are based on internal volumes of the bodies 704, 708 and/or a number of the door holes 710. Furthermore, the polygonal body 708 includes a bleed hole 712 to adjust or tune the resonant frequency the polygonal damper assembly 702b is able to dampen.

The triangular body 704 and the polygonal body 708 of FIGS. 7A and 7B can collapse and/or inflate based on input signals. For example, the triangular damper assembly 702a and/or the polygonal body 702b can include smart metals or shape-memory alloys (SMAs) that can assume the shapes illustrated in FIGS. 7A and/or 7B based on temperature, electrical stimulation, air pressure, etc. Thus, the internal volumes of the triangular damper assembly 702a and/or the polygonal damper assembly 702b can be adjusted during operation based on a current (e.g., measured) resonance of the VBV cavity 228.

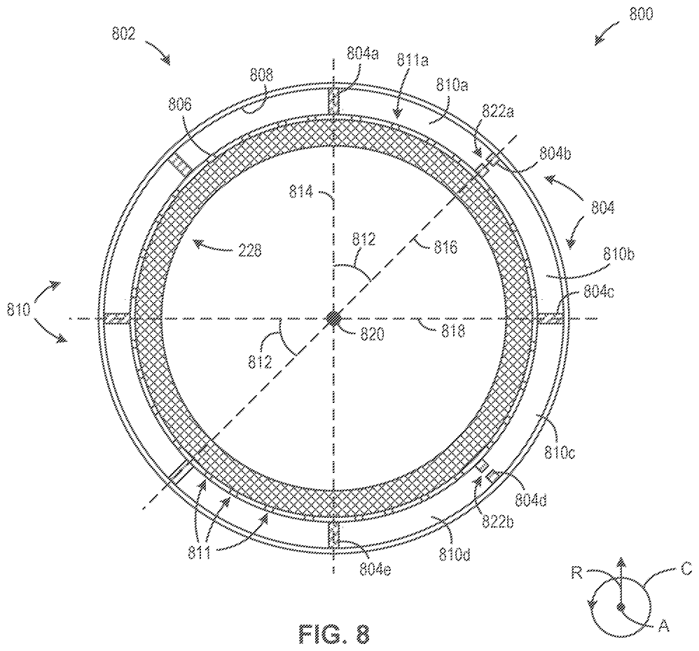

FIG. 8 is a cross-sectional front view of a sixth VBV assembly 800 (e.g., a sixth VBV system) including a damper system 802 in accordance with teachings disclosed herein. In some examples, the sixth VBV assembly 800 of FIG. 8 implements the VBV assemblies 400, 600a, 600b, 700a, and/or 700b of FIGS. 4A-4C, 6A, 6B, 7A, and/or 7B. Furthermore, in some examples, the damper system 802 of FIG. 8 implements the twin damper system 402 of FIGS. 4A-4C and/or the damper assemblies 602a, 602b, 702a, and/or 702b of FIGS. 6A, 6B, 7A, and/or 7B.

In the illustrated example of FIG. 8, the damper system 802 includes a plurality of partitions 804 coupled to a door 806 (e.g., the VBV door 408 of FIGS. 4A-4C, etc.) and an interior surface 808 (e.g., the interior surface 414 of FIGS. 4A-4C, etc.). The partitions 804 of FIG. 8 extend axially along the door 806 and define a plurality of resonators or a plurality of bodies 810 of the damper system 802. For example, a first body 810a extends circumferentially from a first partition 804a to a second partition 804b. In some examples, the first body 810a of FIG. 8 implements the bodies 406, 604, 704, and/or 708 of FIGS. 4A-4C, 6A, 6B, 7A, and/or 7B. Furthermore, the damper system 802 includes a plurality of door holes 811 to permit air pressure oscillations (e.g., sound waves) to enter the bodies 810. For example, the first body 810a includes a first door hole 811a. The first door hole 811a can implement the first door hole 420 and/or the second door hole 422 of FIGS. 4A-4C, one of the plurality of door holes 614 of FIGS. 6A and/or 6B, and/or one of the door holes 710 of FIGS. 7A and/or 7B.

Additionally, in the illustrated example of FIG. 8, the damper system 802 includes a second body 810b, a third body 810c, and a fourth body 810d. The second body 810b extends circumferentially between the second partition 804b and a third partition 804c. The third body 810c extends circumferentially between the third partition 804c and a fourth partition 804d. The fourth body 810d extends circumferentially between the fourth partition 804d and a fifth partition 804e.

In the illustrated example of FIG. 8, the partitions 804 are spaced circumferentially apart by an angle 812 (e.g., 45 degrees, 30 degrees, 60 degrees, etc.). Thus, the bodies 810 include similar internal volumes (e.g., within +/−5%). More specifically, the first partition 804a is radially and axially aligned with a first lateral axis 814, the second partition 804b is radially and axially aligned with a second lateral axis 816, and a third partition 804c is radially and axially aligned with a third lateral axis 818. The lateral axes 814-818 intersect and are orthogonal to a longitudinal axis 820 of the compressor 200 (e.g., the axial centerline axis 112 of FIG. 1). Furthermore, the second lateral axis 816 is oriented at the angle 812 relative to the first lateral axis 814, and the third lateral axis 818 is oriented at the angle 812 relative to the second lateral axis 816.

In some examples, the plurality of partitions 804 are circumferentially spaced at variable distances to define different internal volumes of the bodies 810. Thus, the damper system 802 can dampen a range or a plurality of resonant frequencies (e.g., 550 Hz and 1010 Hz, 300-700 Hz, etc.) from the VBV cavity 228. Additionally or alternatively, the partitions 804 can include holes to permit acoustic waves to propagate between adjacent ones of the bodies 810, which adjusts the resonant frequencies the damper system 802 can dampen.

In the illustrated example of FIG. 8, the second partition 804b includes a first partition hole 822a to connect an internal volume of the first body 810a and an internal volume of a second body 810b. Additionally, the fourth partition 804d includes a second partition hole 822b to connect an internal volume of the third body 810c and an internal volume of the fourth body 810d. Thus, the first partition hole 822a combines the first and second bodies 810a, 810b, and the second partition hole 822b combines the third and fourth bodies 810c, 810d. Thus, for example, after air pressure oscillations enter the first door hole 811a, the sound waves can propagate between the first body 810a and the second body 810b via the first partition hole 822a.

The attenuation performance of a damper, such as the first body 810a, is based on the internal volume of the damper. Thus, increasing the internal volume of the damper improves attenuation of sound waves at a lower frequency (e.g., 250 Hz, etc.). By contrast, reducing the internal volume of the damper improves attenuation of sound waves at a higher frequency (e.g., 700 Hz, etc.). Thus, the damper system 802 of FIG. 8 includes the first partition hole 822a to combine the internal volumes of the first and second bodies 810a, 810b and enable the damper system 802 to dampen an additional resonant frequency of the VBV cavity 228. In some examples, other ones of the partitions 804 also include partition holes to further adjust the range of frequencies the damper system 802 can attenuate. In other words, a number of the partitions 804 and a number of partition holes can be adjusted based on the resonant frequencies to be attenuated by the damper system 802.

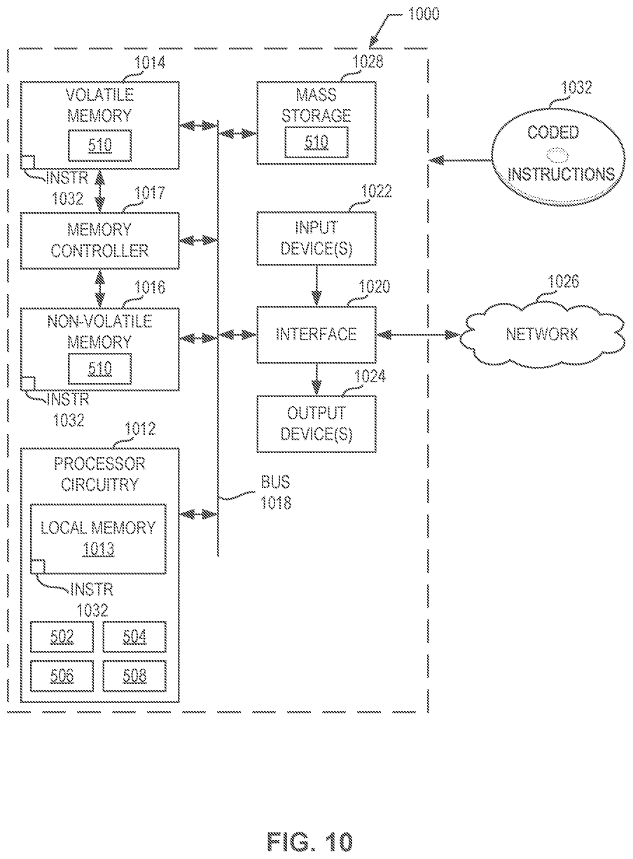

A flowchart representative of example machine readable instructions, which may be executed to configure and/or cause programmable circuitry to implement the controller 424 of FIGS. 4A, 4B, 4C, and 5, is shown in FIG. 9. The machine readable instructions may be one or more executable programs or portion(s) of an executable program for execution by programmable circuitry, such as processor circuitry 1012 shown in an example processor platform 1000 discussed below in connection with FIG. 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with programmable circuitry located in one or more hardware devices, but the entire program and/or parts thereof could alternatively be executed by one or more hardware devices other than the programmable circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 9, many other methods of implementing the example controller 424 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 9 may be implemented using executable instructions (e.g., computer and/or machine readable instructions) stored on at least one non-transitory computer and/or machine readable media and/or medium such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 9 is a flowchart representative of example machine readable instructions and/or example operations 900 that may be executed and/or instantiated by programmable circuitry to adjust a range of resonant frequencies that the twin damper system 402 of FIGS. 4A-4C can dampen. The example machine readable instructions and/or the operations 900 of FIG. 9 help ensure a broad and a narrow range of resonant frequencies of the VBV port 214 and/or VBV cavity 228 can be dampened using the twin damper system 402. The machine readable instructions and/or the operations 900 of FIG. 9 begin at block 902, at which the controller 424 detects a resonant frequency of the VBV port 214 of FIGS. 2, 4A-4C. For example, the interface circuitry 502 of FIG. 5 obtains a resonant frequency measurement from the acoustic sensor 430 of FIGS. 4A-4C.

At block 904, the controller 424 determines whether resonant frequency of the VBV port 214 satisfies a threshold (e.g., 500 Hz, 800 Hz, 1000 Hz, etc.). For example, the frequency determination circuitry 504 of FIG. 5 determines whether the measured frequency satisfies (e.g. is greater than or equal to) the threshold. Additionally or alternatively, the frequency determination circuitry 504 can determine whether a resonant frequency detected via the acoustic sensor 430 satisfies (e.g., is within) a first range of resonant frequencies corresponding to a first resonant mode of the VBV port 214 or a second range of resonant frequencies corresponding to a second resonant mode of the VBV port 214. When the resonant frequency does not satisfy the threshold, control proceeds to block 910. When the resonant frequency does satisfy the threshold, control proceeds to block 906.

At block 906, the controller 424 determines whether the VBV door 408 is in the intermediate position 404b of FIG. 4B. For example, the position determination circuitry 506 can obtain position measurement data from the interface circuitry 502 and/or the position sensor 428 and determine whether the position measurement data corresponds to the intermediate position 404b. When the VBV door 408 is in the intermediate position 404b, control proceeds to block 910. When the VBV door 408 is not in the intermediate position 404b, control proceeds to block 908.

At block 908, the controller 424 moves the VBV door 408 to the intermediate position 404b. For example, the door controller circuitry 508 can cause an actuator (e.g., motor, gear, rod, etc.) to slide the VBV door 408 into the intermediate position 404b such that the second door hole 422 of FIGS. 4A-4C is exposed to the VBV cavity 228.

At block 910, the controller 424 determines whether to open the VBV door 408. For example, the position determination circuitry 506 can determine whether the interface circuitry 502 received a command or input to open the VBV door 408 and permit air to flow along the bleed flow path 216 of FIGS. 4A-4C. In some examples, a pilot of the aircraft triggers the opening of the VBV door 408 based on a flight condition. In other examples, the interface circuitry 502 receives an automatic command to open the VBV door 408 based on stall conditions detected in the booster section 202 and/or the HP compressor section 204 of FIG. 2. When the VBV door 408 is not to open, control proceeds to block 914. When the VBV door 408 is to open, control proceeds to block 912.

At block 912, the controller 424 moves the VBV door 408 to the open position 404c of FIG. 4C. For example, the example door controller circuitry 508 causes an actuator to move the VBV door 408 to the open position 404c such that the VBV port exit 218 of FIG. 4C is fully or partially unobstructed.

At block 914, the controller 424 determines whether flight operations are to continue for the aircraft. For example, the position determination circuitry 506 determines whether the interface circuitry 502 obtained and/or received a command and/or input corresponding to a shut off or cessation of flight operations, such as an indication that the aircraft is landing, taxiing, idling, etc. When flight operations are to continue (e.g., aircraft is still in flight), control returns to block 902. When flight operations are to end, control proceeds to block 916 at which the controller 424 moves the VBV door 408 to the closed position 404a of FIG. 4C. For example, the door controller circuitry 508 causes an actuator to move the VBV door 408 to a position that fully obstructs the VBV port exit 218. After block 916, the example machine readable instructions and/or operations 900 end.

FIG. 10 is a block diagram of an example processor platform 1000 structured to execute and/or instantiate the machine readable instructions and/or the operations of FIG. 9 to implement the controller 424 of FIGS. 4A, 4B, 4C, and 5. The processor platform 1000 can be, for example, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, a full authority digital engine (or electronics) control (FADEC), an avionics system, or another type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example interface circuitry 502, the example frequency determination circuitry 504, the example position determination circuitry 506, the example door controller circuitry 508, and/or, more generally, the example controller 424.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example of FIG. 10, one or more input devices 1022 are connected to the interface circuitry 1020. The input device(s) 1022 permit(s) a user to enter data and/or commands into the processor circuitry 1012. The input device(s) 1022 can be implemented by, for example, a keyboard, a button, a mouse, a touchscreen, a trackpad, a trackball, an isopoint device, and/or a control panel.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a control panel, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIG. 9, may be stored in the mass storage device 1028, in the volatile memory 1014, in the non-volatile memory 1016, and/or on a removable non-transitory computer readable storage medium such as a CD or DVD.

Example variable bleed valve (VBV) assemblies (also referred to herein as “variable bleed valve apparatus” or “variable bleed valve systems”) are disclosed herein that include a VBV port extending radially outward from a compressor section of a gas turbine engine and a door positioned at an exit of the VBV port. The VBV port can produce significant noise at a resonant frequency based on internal dimensions of the VBV port and a closed position of the door. The resonant frequency can cause air pressure to increase at the VBV assembly and oscillate toward a low pressure region of the gas turbine engine (e.g., booster section, inlet section, etc.). Such oscillations can excite mechanical components of the engine, such as rotor blisks, which can reduce performance of the engine, damage the components, increase wear, etc.

Some example VBV assemblies disclosed herein include a twin damper system coupled to the door. The twin damper system includes a body extending circumferentially around a longitudinal axis of the gas turbine engine. The body includes an interior partition within a chamber defining a first damper and a second damper. The body further includes a first door hole to permit air into the first damper, a second hole to permit air into the second damper, and a partition hole to permit air between the first and second dampers. Air pressure oscillations associated with the resonant frequency pass through the first and/or second hole(s) and the sound waves reflect within the first damper and/or the second damper. The reflected waves and incident waves interact in the dampers, which converts the energy of the sound waves into generate heat. The resonant frequency that the dampers are able to attenuate is based on internal dimensions of the respective dampers.

A wall of the VBV port obscures the second door hole based on a closed position of the door. Furthermore, the first door hole is exposed when the door is in the closed position. Thus, the first damper can attenuate noise at a first resonant frequency based on dimensions of the first damper and the closed position of the door. The second door hole becomes exposed based on a partially open position of the door. Thus, the second damper can attenuate noise at a second resonant frequency based on dimensions of the second damper and the closed position of the door. In some examples, the first damper has a greater internal volume than the second damper. Thus, the first damper can attenuate a lower resonant frequency than the second damper. The twin damper system can actuate the door to the closed position when the VBV port generates noise at the first resonant frequency. The twin damper system can also actuate the door to the partially open position when the VBV port produces a noise at the second frequency. In some examples, an operating condition (e.g., air speed) of the gas turbine engine causes the resonant frequency of the VBV port to change (e.g., increase or double). Thus, example twin damper systems disclosed herein attenuate noise associated with multiple resonant frequencies of the VBV port.

Examples apparatus, systems, and methods to reduce resonant frequencies of variable bleed valve assemblies are disclosed herein. Further examples and combinations thereof include the following:

An apparatus comprising a variable bleed valve port extending radially outward from a main flow path of a gas turbine engine, a door positioned at an exit of the variable bleed valve port, the door including perforations, and a damper coupled to the door, the damper including a resonator adjacent to the perforations of the door, the resonator defining an internal volume based on a resonant frequency of the variable bleed valve port.

The apparatus of any preceding clause, wherein the damper extends circumferentially around the gas turbine engine, the damper including a first partition and a second partition spaced circumferentially apart from one another, the first partition and the second partition extending axially along the door, the first partition and the second partition defining the internal volume of the resonator.

The apparatus of any preceding clause, wherein the resonator includes an interior surface radially spaced from the door, the interior surface being non-uniform.

The apparatus of any preceding clause, wherein the resonator is a first resonator, the damper including an interior partition defining the first resonator and a second resonator, the interior partition coupled to the door and the interior surface, the interior partition extending circumferentially along the door.

The apparatus of any preceding clause, wherein the interior partition includes a partition hole extending through the interior partition between the first resonator and the second resonator.

The apparatus of any preceding clause, wherein the perforations are first perforations positioned adjacent to the first resonator, the damper including second perforations positioned adjacent to the second resonator.

The apparatus of any preceding clause, wherein the door is slidable to an intermediate position between an open position and a closed position, the variable bleed valve port including an aft wall obstructing the second perforations when the door is in the closed position, the second perforations exposed when the door is in the intermediate position.

The apparatus of any preceding clause, further including a controller, a position sensor, and an acoustic sensor, the controller including programmable circuitry to obtain frequency data from the acoustic sensor, the frequency data corresponding to the resonant frequency of the variable bleed valve port, obtain position data from the position sensor, the position data corresponding to a displacement of the door, determine whether the resonant frequency of the variable bleed valve port satisfies a threshold, and move the door to the intermediate position when the resonant frequency satisfies the threshold.

The apparatus of any preceding clause, wherein the damper includes an acoustic liner disposed within a body of the damper, the acoustic liner coupled to an outer wall of the damper.

The apparatus of any preceding clause, wherein the acoustic liner corresponds to a quarter wave panel having a plurality of cavities extending through the acoustic liner to the outer wall.

The apparatus of any preceding clause, wherein the acoustic liner defines a ridged surface profile.

The apparatus of any preceding clause, wherein the acoustic liner defines a triangular surface profile.

A variable bleed valve system for a gas turbine engine, the variable bleed valve system comprising a port extending radially outward from a main flow path of the gas turbine engine, a door positioned at an exit of the port, the door including a first hole and a second hole, and a damper coupled to the door, the damper including a first resonator defining a first internal volume based on a first resonant mode of the port, the first resonator positioned adjacent to the first hole of the door, and a second resonator defining a second internal volume based on a second resonant mode of the port, the second internal volume different than the first internal volume, the second resonator positioned adjacent to the second hole of the door.

The variable bleed valve system of any preceding clause, wherein the damper includes an interior partition defining the first resonator and the second resonator, the interior partition extending circumferentially along the door, the interior partition including a partition hole extending between the first resonator and the second resonator. Example 15 includes the variable bleed valve system of example 13, wherein the first hole is exposed, the second hole is obstructed when the door is in a closed position, the second hole being unobstructed when the door is in the intermediate position.

The variable bleed valve system of any preceding clause, further including a controller to actuate the door between a closed position, an open position, and an intermediate position, the controller including position determination circuitry to determine whether to move the door to the intermediate position, and door controller circuitry to move the door between the closed position, the open position, and the intermediate position.

The variable bleed valve system of any preceding clause, wherein the controller includes interface circuitry to obtain frequency data from an acoustic sensor, the frequency data corresponding to a resonant frequency of the port, and frequency determination circuitry to determine whether the resonant frequency satisfies a threshold, the position determination circuitry to determine whether to move the door to the intermediate position based on the resonant frequency and the threshold.

The variable bleed valve system of any preceding clause, wherein the controller includes interface circuitry to obtain an input corresponding to a command to move the door to the intermediate position, the door controller circuitry to move the door to the intermediate position based on the input.

The variable bleed valve system of any preceding clause, wherein the controller includes interface circuitry to obtain an air speed of the gas turbine engine, the position determination circuitry to determine whether to move the door to the intermediate position based on the air speed, the door controller circuitry to move the door to the intermediate position based on the air speed.

A method for attenuating a resonant frequency of a variable bleed valve (VBV) port using a controller and a damper system coupled to a VBV door, the method comprising obtaining a resonant frequency of the VBV port, determining whether the resonant frequency satisfies a threshold, and causing the VBV door to move an intermediate position when the resonant frequency satisfies the threshold.

The method of any preceding clause, further including determining whether the VBV door is in the intermediate position after a first determination that the resonant frequency satisfies the threshold.

The method of any preceding clause, wherein the causing of the VBV door to move is after a second determination that the VBV door is not in the intermediate position.

The method of any preceding clause, further including determining whether to open the VBV door, and causing the VBV door to move to an open position after a determination that the VBV door is to open.

The method of any preceding clause, further including determining whether to continue flight operations, and causing the VBV door to move to a closed position after a determination that the flight operations are not to continue.

Although certain example systems, apparatus, and articles of manufacture have been disclosed herein, the scope of coverage of this patent is not limited thereto. On the contrary, this patent covers all systems, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a variable bleed valve port extending radially outward from a main flow path of a gas turbine engine;
a door positioned at an exit of the variable bleed valve port, the door including perforations; and
a damper coupled to the door, the damper including a resonator positioned adjacent to the perforations of the door, the resonator defining an internal volume based on a resonant frequency of the variable bleed valve port.

2. The apparatus of claim 1, wherein the damper extends circumferentially around the gas turbine engine, the damper including a first partition and a second partition spaced circumferentially apart from one another, the first partition and the second partition extending axially along the door, the first partition and the second partition defining the internal volume of the resonator.

3. The apparatus of claim 1, wherein the resonator includes an interior surface radially spaced from the door, the interior surface being non-uniform.

4. The apparatus of claim 3, wherein the resonator is a first resonator, the damper including an interior partition defining the first resonator and a second resonator, the interior partition coupled to the door and the interior surface, the interior partition extending circumferentially along the door.

5. The apparatus of claim 4, wherein the interior partition includes a partition hole extending through the interior partition between the first resonator and the second resonator.

6. The apparatus of claim 4, wherein the perforations are first perforations positioned adjacent to the first resonator, the damper including second perforations positioned adjacent to the second resonator.

7. The apparatus of claim 6, wherein the door is slidable to an intermediate position between an open position and a closed position, the variable bleed valve port including an aft wall obstructing the second perforations when the door is in the closed position, the second perforations exposed when the door is in the intermediate position.

8. The apparatus of claim 7, further including a controller, a position sensor, and an acoustic sensor, the controller including programmable circuitry to:
obtain frequency data from the acoustic sensor, the frequency data corresponding to the resonant frequency of the variable bleed valve port;
obtain position data from the position sensor, the position data corresponding to a displacement of the door;
determine whether the resonant frequency of the variable bleed valve port satisfies a threshold; and
move the door to the intermediate position when the resonant frequency satisfies the threshold.

9. The apparatus of claim 1, wherein the damper includes an acoustic liner disposed within a body of the damper, the acoustic liner coupled to an outer wall of the damper.

10. The apparatus of claim 9, wherein the acoustic liner corresponds to a quarter wave panel having a plurality of cavities extending through the acoustic liner to the outer wall.

11. The apparatus of claim 9, wherein the acoustic liner defines a ridged surface profile.

12. The apparatus of claim 9, wherein the acoustic liner defines a triangular surface profile.

13. A variable bleed valve system for a gas turbine engine, the variable bleed valve system comprising:
a port extending radially outward from a main flow path of the gas turbine engine;
a door positioned at an exit of the port, the door including a first hole and a second hole; and
a damper coupled to the door, the damper including:
a first resonator defining a first internal volume based on a first resonant mode of the port, the first resonator positioned adjacent to the first hole of the door; and
a second resonator defining a second internal volume based on a second resonant mode of the port, the second internal volume different than the first internal volume, the second resonator positioned adjacent to the second hole of the door.

14. The variable bleed valve system of claim 13, wherein the damper includes an interior partition defining the first resonator and the second resonator, the interior partition extending circumferentially along the door, the interior partition including a partition hole extending between the first resonator and the second resonator.

15. The variable bleed valve system of claim 13, wherein the first hole is exposed, the second hole is obstructed when the door is in a closed position, the second hole being unobstructed when the door is in an intermediate position.

16. The variable bleed valve system of claim 13, further including a controller to actuate the door between a closed position, an open position, and an intermediate position, the controller including:
position determination circuitry to determine whether to move the door to the intermediate position; and
door controller circuitry to move the door between the closed position, the open position, and the intermediate position.

17. The variable bleed valve system of claim 16, wherein the controller includes:
interface circuitry to obtain frequency data from an acoustic sensor, the frequency data corresponding to a resonant frequency of the port; and
frequency determination circuitry to determine whether the resonant frequency satisfies a threshold, the position determination circuitry to determine whether to move the door to the intermediate position based on the resonant frequency and the threshold.

18. The variable bleed valve system of claim 16, wherein the controller includes interface circuitry to obtain an input corresponding to a command to move the door to the intermediate position, the door controller circuitry to move the door to the intermediate position based on the input.

19. The variable bleed valve system of claim 16, wherein the controller includes interface circuitry to obtain an air speed of the gas turbine engine, the position determination circuitry to determine whether to move the door to the intermediate position based on the air speed, the door controller circuitry to move the door to the intermediate position based on the air speed.

20. A method for attenuating a resonant frequency of a variable bleed valve (VBV) port using a controller and a damper system coupled to a VBV door, the method comprising:
obtaining a resonant frequency of the VBV port;
determining whether the resonant frequency satisfies a threshold; and
causing the VBV door to move an intermediate position when the resonant frequency satisfies the threshold.
